(19) United States
(12) Patent Application Publication
(10) Pub. No.: US 2006/0208441 A1
(43) Pub. Date: Sep. 21, 2006

(54) Mobile device

(75) Inventor: Ying-Shi Lin, Taipei (TW)

Correspondence Address: BIRCH STEWART KOLASCH & BIRCH, PO BOX 747, FALLS CHURCH, VA, 22040-0747, US

(73) Assignee: BENQ CORPORATION, Taoyuan (TW)

(21) Appl. No.: 11/369,853

(22) Filed: Mar. 8, 2006

(30) Foreign Application Priority Data
Mar. 9, 2005 (TW) 94107104

(51) Int. Cl. B62B 1/00

(52) U.S. Cl. 280/47.131

(57) ABSTRACT

A mobile device. The mobile device comprises a body and a supporting element. The body comprises a first portion and a second portion. The supporting element is detachably connected to the first or the second portion of the body. The supporting element supports the body at an inclined angle with respect to a plane when the supporting element is disposed at the first portion of the body. The supporting element becomes a phone strap when the supporting element is disposed at the second portion of the body.

### BACKGROUND

The invention relates to a mobile device, and in particular to a mobile device with a supporting mechanism.

The functionalities provided by mobile devices such as mobile phones have continuously increased, and the extraordinary design of mobile devices is often symbolize of a user's lifestyle. Consumers not only demand the mobile device to be of good communication quality with friendly user interface, but have additional functions such as camera, low power-consumption, and a large screen. Appearance is also critical. Thus, both functionality and appearance of mobile devices have become critical design goals. For example, an addition of a cell phone strap can easily attract attention.

Conventional cell phone straps, however, are merely decorative, but not functional nor practical. Sometimes, a cell phone strap may be bothersome. Additionally, when the mobile device has a camera, the users must hold the mobile device while taking a picture such that distance and angles are restricted.

### SUMMARY

The invention provides a mobile device comprising a supporting element that can be deployed in various orientations and the supporting element also provides decoration for the mobile device.

Also provided is a mobile device comprising a body and a supporting element. The body comprises a first portion and a second portion. The supporting element is detachably connected to the first or the second portion of the body. The supporting element supports the body at an inclined angle with respect to a plane when the supporting element is disposed at the first portion of the body. The supporting element becomes a phone strap to be held or hung when the supporting element is disposed at the second portion of the body.

The first portion comprises a groove, formed on a surface thereof. The second portion comprises a through hole, defined at a corner thereof.

The supporting element comprises a hanging portion, detachably connected to the second portion, and a supporting portion, detachably connected to the first portion. The hanging portion comprises a thin strap, and the second portion comprises a through hole.

The supporting portion comprises an upper part, a lower part, and a rotary shaft, connecting the upper and lower parts. When the upper part of the supporting element is connected to the first portion of the body, the rotary shaft allows the lower part rotate with respect to the body.

The supporting element comprises elastic materials. When the supporting element is connected to the first portion, after bending elastically, the supporting element forms an angle with the body.

In an embodiment, the supporting element comprises a first engaging portion, and the body further comprises a second engaging portion, disposed on the first portion; when the supporting element is connected to the first portion of the body, the first engaging portion is inserted in the second engaging portion.

The first engaging portion comprises a convex portion, and the second engaging portion comprises a concave portion.

In another embodiment, the first engaging portion comprises a concave portion, and the second engaging portion comprises a convex portion.

### BRIEF DESCRIPTION OF THE DRAWINGS

The invention can be more fully understood by reading the subsequent detailed description in conjunction with the examples and references made to the accompanying drawings, wherein:

FIG. 1 is a perspective view of a mobile device of the invention;

FIG. 2 is a rear exploded view of a mobile device of the invention;

FIG. 3 is a side view of a mobile device of the invention;

FIG. 4 is a rear view of a mobile device of the invention.

### DETAILED DESCRIPTION

While mobile devices disclosed of the invention are phones, the characteristics of the invention is not limited thereto and is applicable to other mobile devices such as cameras, personal digital assistants (PDAs), notebook computers, and the like.

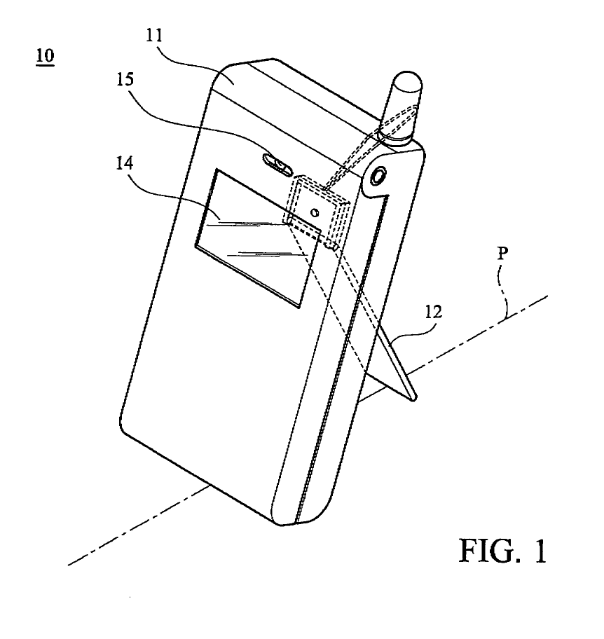

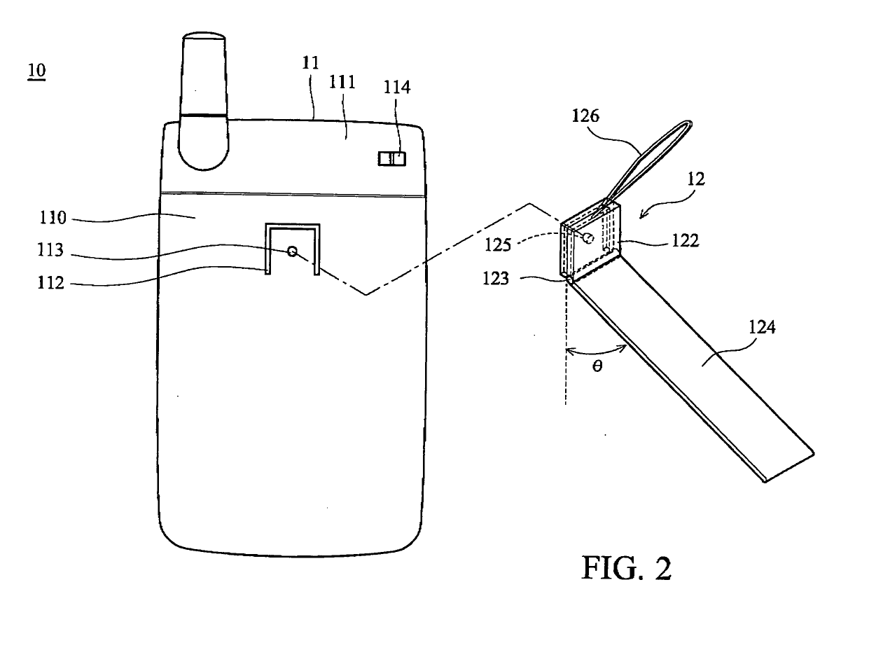

FIG. 1 is a perspective view of a mobile device 10 of the invention. FIG. 2 is a rear exploded view of a mobile device 10, in which the body 11 and the supporting element 12 are separated to clearly show the rear side of the body 11. Note that the mobile phone having a flip-cover is provided as an example; the invention can be applied to other types of mobile phones such as upright, sliding and other structures.

As shown in FIGS. 1 and 2, the mobile device 10 comprises a body 11, a screen 14, a lens 15, and a supporting element 12. The screen 14 and the lens 15 are disposed on the body 11. The body 11 comprises a first portion 112 and a second portion 114. In this embodiment, the first portion 1112 comprises a groove, defined on a surface of the body 11. The second portion 114 comprises a through hole, which can be defined at a corner for example.

The supporting element 12 is detachably connected to the first portion 112 or the second portion 114 of the body 11. When the supporting element 12 is disposed on the first portion 112, as shown in FIG. 1, the supporting element 12 is engaged with the body 11. at an inclined angle while the mobile device 10 is supported (by the supporting element 12) upright on the plane P, such as a desk surface.

In this embodiment, the supporting element 12 comprises an upper part 122, a lower part 124, and a rotary shaft 123 connecting the upper and lower parts 122 and 124. The lower part 124 can comprise metal or plastic materials for greater strength. The supporting element 12 further comprises a first engaging portion 125 comprising a convex portion. the first engaging portion 125 is disposed on the middle of the upper part 122. The body 11 further comprises a second engaging portion 113, which can be a concave portion, disposed on the first portion 112, which is a groove. The second engaging portion 113 (concave portion) corresponds to the first engaging portion 125 (convex portion). When the supporting element 12 is connected to the first portion 112 of the body 11, the first engaging portion 125 is combined with the second engaging portion 113.

Note that, in some embodiments, the first engaging portion 125 comprises a concave portion, and the second engaging portion 113 comprises a convex portion.

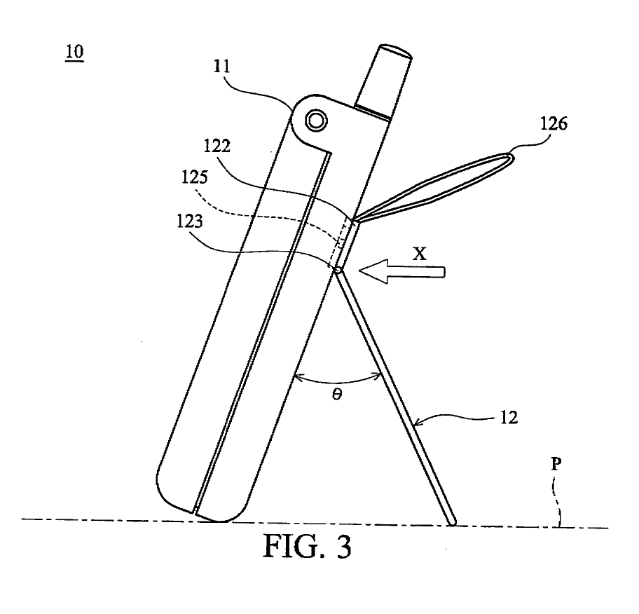

As shown in FIG. 3, after rotating the rotary shaft 123 an angle θ with respect to the body 11, applying a force in direction × such that the upper part 122 of the supporting element 12 is connected to the first portion 112 of the body 11, and an angle θ is formed between the lower part 124 of the supporting element 12 and the body 11. Additionally, the angle θ is determined by users; and thus, the invention does not limit the rotational angle θ. Hence, when an user operates the camera of the mobile device 10 or talks on the phone via earphones, the supporting element 12 can be rotated to allow the mobile device 10 to stand upright on a plane P, thus providing more convenient operation.

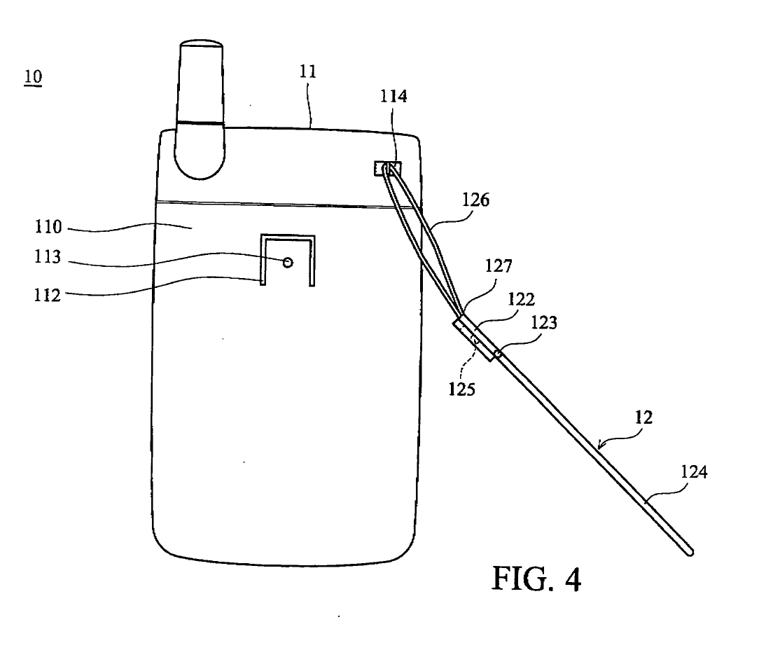

FIG. 4 is a rear view of a mobile device 10 of the invention in another position. When the supporting element 12 is disposed on the second portion 114 of the body 11, the supporting element 12 acts as a phone strap. The supporting element 12 comprises a hanging portion 126, detachably connected to the second portion 114 on the upper part 122, and a supporting portion 124, detachably connected to the first portion 112. The hanging portion 126 comprises a thin strap or other linear element. When the supporting element 12 acts as a phone strap, the hanging portion 126 passes through the through hole (second portion) 114 to connect the body 11 and the supporting element 12. Thus, the mobile device 10 can be held or hung by the hanging portion 126.

In a variation of the described embodiments, the supporting element 12 comprises elastic materials, and is integrally formed. When the supporting element 12 is connected to the first portion 112, after bending elastically, an angle is formed between the supporting element 12 and the body 11.

In conclusion, when the mobile device is used to take a still picture or used as a web-camera, the supporting element (strap) 12 can be detached and connected to the first portion 112 at the rear of the mobile device. The supporting element 12 is rotated with respect to the body 11 by the rotary shaft 123 at an angle, or the supporting element 12 is elastically bent, the mobile device 10 can be positioned upright on a desk P for the best photographic angle. The design does not influence other functions of the mobile device and the supporting elements can provide various functionalities.

The supporting element of the invention provides both supporting and hanging functions, and thus, not only provides an artistic appearance but also supports the mobile device in an upright position. Since the structure is simple, the assembly is easy and does not increase manufacturing costs.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A mobile device, comprising:
a body, comprising a first portion and a second portion; and
a supporting element, detachably connected to the first or the second portion of the body;
wherein when the supporting element is disposed on the first portion of the body, an angle is formed between the supporting element and the body;
wherein when the supporting element is disposed on the second portion of the body, the body can be hung or held via the supporting element.

2. The mobile device as claimed in claim 1, wherein the first portion comprises a groove, formed on a surface of the mobile device.

3. The mobile device as claimed in claim 1, wherein the second portion comprises a through hole, defined on the mobile device.

4. The mobile device as claimed in claim 1, wherein the supporting element comprises a hanging portion detachably connected to the second portion, and a supporting portion detachably connected to the first portion.

5. The mobile device as claimed in claim 4, wherein the hanging portion comprises a strap, and the second portion comprises a through hole.

6. The mobile device as claimed in claim 4, wherein the supporting portion comprises an upper part, a lower part, and a rotary shaft, the rotary shaft connecting the upper and lower parts; wherein when the upper part of the supporting element is connected to the first portion of the body, the rotary shaft allows the lower part to rotate with respect to the body.

7. The mobile device as claimed in claim 4, wherein the supporting element comprises elastic materials.

8. The mobile device as claimed in claim 7, wherein when the supporting element is connected to the first portion, the supporting element is bent such that an angle is formed between the supporting element and the body.

9. The mobile device as claimed in claim 1, wherein the supporting element comprises a first engaging portion, and the body further comprises a second engaging portion disposed on the first portion; wherein when the supporting element is connected to the first portion of the body, the first engaging portion is combined with the second engaging portion.

10. The mobile device as claimed in claim 9, wherein the first engaging portion comprises a convex portion, and the second engaging portion comprises a concave portion.

11. The mobile device as claimed in claim 9, wherein the first engaging portion comprises a concave portion, and the second engaging portion comprises a convex portion.
